(19) United States
(12) Patent Application Publication
(10) Pub. No.: US 2026/0180158 A1
(43) Pub. Date: Jun. 25, 2026

(54) TAPE TRANSFER APPARATUS

(71) Applicant: Dover Europe Sàrl, Vernier (CH)

(72) Inventors: Biser Ivanov, Nottingham (GB); Mike SMITH, Nottingham (GB); John CHAMBERS, Nottingham (GB)

(21) Appl. No.: 19/128,258

(22) PCT Filed: Nov. 8, 2023
(86) PCT No.: PCT/EP2023/081228

§ 371 Date: May 8, 2025

(30) Foreign Application Priority Data
Nov. 8, 2022 (GB) 2216620.1

(51) Int. Cl. H01Q 1/24; H01Q 1/38

(52) U.S. Cl. CPC H01Q 1/243; H01Q 1/38

(57) ABSTRACT

A tape transfer apparatus (10) including a base part (12) and at least one spool support (14, 16) for receiving a spool of tape (18, 20), the spool support (14, 16) being configured to rotate about a first axis of rotation (14a, 16a) relative to the base part (12), the tape transfer apparatus (10) also including an RFID reader (40) configured to read data from an RFID tag (50) associated with a spool of tape (18, 20), when a spool of tape (18, 20) including such an RFID tag (50) is mounted on the spool support (14, 16), wherein at least a part of the RFID reader (40) is positioned on or in a part of the spool support (14, 16).

### FIELD

The invention relates to a tape transfer apparatus, in particular but not exclusively to a transfer printing apparatus.

### BACKGROUND

In the field of thermal transfer printing, inked ribbon (hereinafter □tape□) is typically wound on a first substantially cylindrical hollow core. The core and the spool of tape is mounted onto a spool support, and the spool support is rotatable to transfer tape from the first (supply) spool to a second (take up) spool. The take-up spool also includes a hollow core around which tape may be wound. The core of the take-up spool is mounted on a second spool support which is also rotatable. Various methods of operation of such a reel to reel tape drive are known in the art. Tape is typically transferrable between the pair of spools in both directions, but generally speaking, as ink is removed from the tape during successive printing operations, the used tape is wound onto the second □take-up□ spool, such that the diameter of the supply spool decreases and the diameter of the take-up spool increases.

It is known in the art of printing to identify consumables, for example ink cartridges, or inked ribbon spools, for example to enable characteristics of the consumable to be checked, and suitability of the consumable for use in an apparatus with which it is associated and/or intended to be used. The use of RFID technology is generally known.

In the kind of printing apparatus described above, it is known to provide an RFID tag on an outer surface of the core of a tape spool, and an antenna mounted on the body of the printing apparatus. A disadvantage of this arrangement is that the antenna has to be mounted sufficiently far from the centre of the spool to be able to accommodate a full tape spool, and the rotation of the spool during use means that the distance between the tag positioned on the rotatable core and the stationary antenna varies. In known apparatus, the tag is mounted on a centre-line of the core, so that the tape can be used in a left hand or right hand configuration i.e. the supply spool may be on the left or right of the printer, which may increase the distance between the tag and the antenna. This can mean that communication between the tag and the reader is not as accurate as or reliable as may be desired.

### BRIEF DESCRIPTION OF THE INVENTION

There is provided a tape transfer apparatus including a base part and at least one spool support for receiving a spool of tape, the spool support being configured to rotate about a first axis of rotation relative to the base part, the tape transfer apparatus also including an RFID reader configured to read data from an RFID tag associated with a spool of tape, when a spool of tape including such an RFID tag is mounted on the spool support, wherein at least a part of the RFID reader is positioned on or in a part of the spool support.

An antenna of the RFID reader may be positioned on or in a part of the spool support.

The tape transfer apparatus may include a wireless connection arrangement to transfer at least one of electrical energy, data and signals between a moving part of the tape transfer apparatus and a stationary part of the tape transfer apparatus.

The wireless connection arrangement may be operable to transfer at least one of electrical energy, data and signals between the antenna of the RFID reader and a component positioned on the base part.

The wireless connection arrangement may be operable to transfer at least one of electrical energy, data and signals between the antenna of the RFID reader and a component positioned remotely from the base.

A first part of the connection arrangement may be positioned on the base part and a second part of the connection arrangement may be positioned on or in a part of the spool support, the second part of the connection arrangement being moveable relative to the first part of the connection arrangement.

The first part of the connection arrangement may include a first coil and the second part of the connection arrangement may include a second coil.

The connection arrangement may be an RF transformer.

At least one of the first and second coil may be one of a wound conductive material and a winding on a flexible circuit board.

The first coil and the second coil may be separated from each other by an air gap without a ferromagnetic core.

The tape transfer apparatus may be a thermal transfer printing apparatus.

There is provided a kit including a tape transfer apparatus as described herein and a spool of tape including an RFID tag associated with the spool.

The spool of tape may be a consumable which is replaceable in the tape transfer apparatus.

The spool may include a core configured to receive a length of tape wound around it, the core being directly mountable on a spool support of the tape transfer apparatus.

The RFID tag may be mounted on an outer surface of the core of the spool.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a cross sectional view through a tape path of a typical transfer printer, as an example of a tape transfer apparatus;

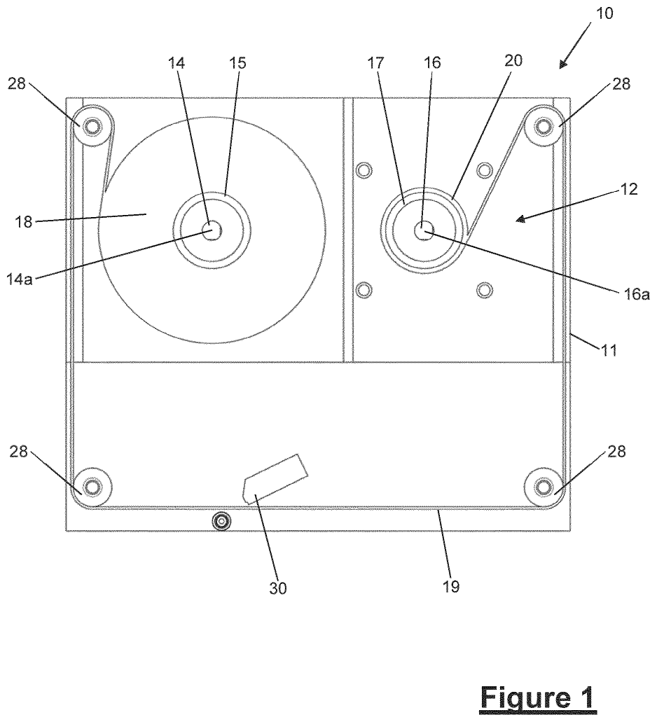

FIG. 2 is a perspective view of a part of the tape transfer apparatus, showing a spool mounted on a spool support;

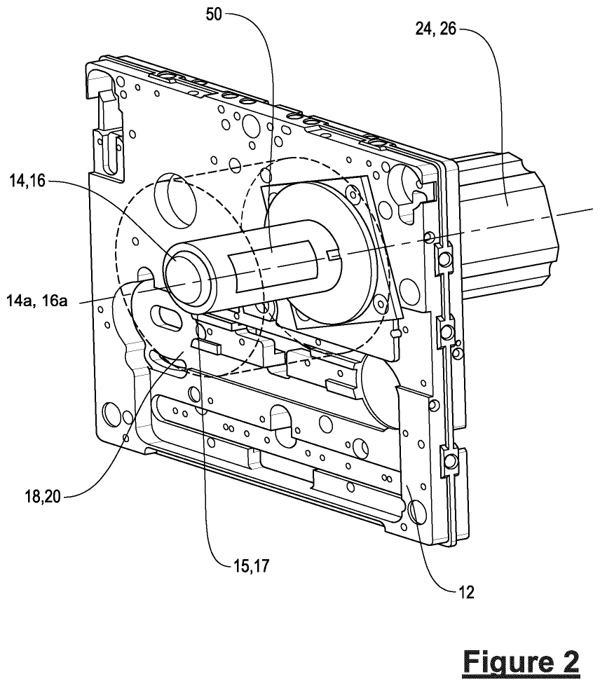

FIG. 3 is an exploded perspective view of a spool, spool support and connection arrangement of the tape transfer apparatus;

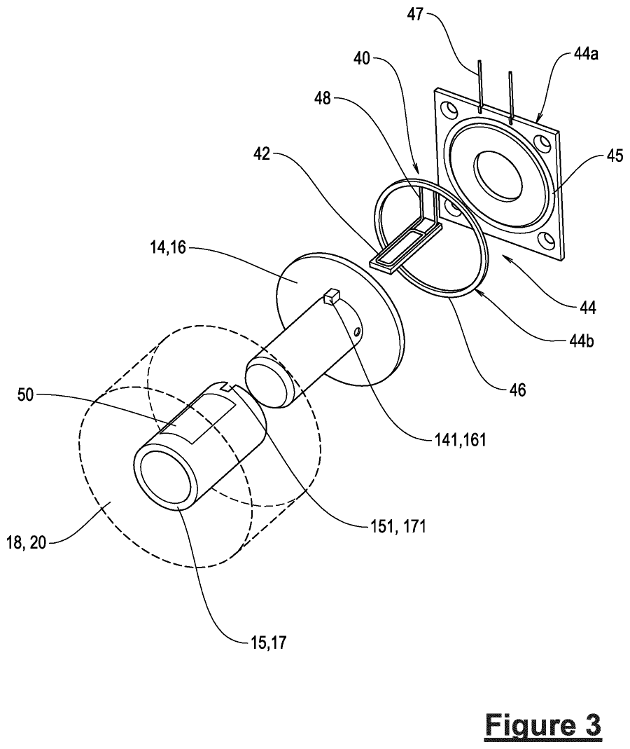

FIG. 4 is an illustrative cross-sectional view of a part of the tape transfer apparatus; and

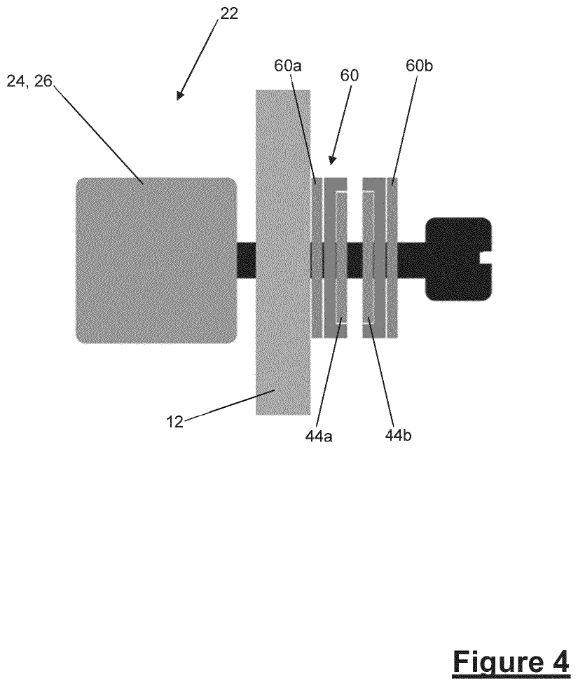

FIG. 5 is an illustrative perspective view of an arrangement of an antenna of the tape transfer apparatus.

### DETAILED DESCRIPTION OF THE DISCLOSURE

Referring to the figures, there is shown a tape transfer apparatus 10, which may be a transfer printing apparatus, for example a thermal transfer printing apparatus. The tape transfer apparatus 10 includes a body 11, including a base part 12. The tape transfer apparatus 10 includes a first spool support 14 and a second spool support 16. Each of the spool supports 14, 16 is configured to support a spool 18, 20 of tape 19. Each of the spool supports 14, 16 may be rotatable to transfer tape 19 from one of the spools 18, 20 to the other. Each spool support 14, 16 may be rotatable about a respective axis of rotation 14a, 16a. Each axis of rotation 14a, 16a may extend substantially longitudinally through the respective spool support 14, 16. Each spool support 14, 16 may be in the form of a spindle. Each spool support 14, 16 may include an opening, such that part of the spool support 14, 16 may be substantially hollow. One or both of the spool supports 14, 16 may be driven by a drive apparatus 22. The drive apparatus 22 may include a spool motor 24 to rotate at least one of the spool supports 14, 16. The tape drive apparatus 10 may include a pair of spool motors 24, 26, each configured to rotate a respective one of the spool supports 14, 16. It will be understood that the spool supports 14, 16 may be driven independently or co-operatively, in any appropriate manner.

The tape 19 extends in a tape path between the spools 18, 20. Guide members 28 may be provided to guide the tape 19 in the tape path. Where the tape transfer apparatus 10 is a printing apparatus, a printhead 30 may be provided to transfer ink from the tape 19 to a substrate during a printing operation.

Each spool 18, 20 may be a consumable item which co-operates with the tape transfer apparatus 10. One or both of the spools 18, 20 may be mounted on the respective spool support 14, 16 directly. One or both spools 18, 20 of tape 19 may be wound on a respective core 15, 17. Each core 15, 17 may be configured to engage with a respective spool support 14, 16. Each core 15, 17 may be substantially hollow to receive at least a part of the corresponding spool support 14, 16. Each core 15, 17 may have a shape which corresponds with the shape of the corresponding spool support 14, 16. Each core 15, 17 may be substantially cylindrical or include a substantially cylindrical part to engage with the respective spool support 14, 16.

One or both cores 15, 17 may include an engagement formation 151, 171 which is engageable with a corresponding engagement formation 141, 161 of the corresponding spool support 14, 16. Engagement of the or each engagement formation 151, 171 of the core 15, 17 with the corresponding engagement formation 141, 161 of the corresponding spool support 14, 16 may ensure that the orientation of the core 15, 17 is optimised and/or substantially fixed relative to the corresponding spool support 14, 16.

One of the spools 18, 20 may be mounted on the respective spool support 14, 16 with a length of tape 19 wound thereon, for example in a substantially □full□ configuration. The other spool 18, 20 may be mounted on its respective spool support 14, 16 with little or no tape 19 wound thereon, for example in a substantially empty configuration. One of the spools 18, 20 may be configured as a supply spool and the other spool 18, 20 may be configured as a take up spool, for example to take up used tape, for example tape from which ink has been removed. It will be appreciated that owing to the nature of the tape transfer, the supply spool may at certain times take up a length of tape 19 from the tape path and the take up spool may supply a length of tape to the tape path, for example to reverse the direction of travel of the tape. This is in accordance with known tape transfer principles. It will also be appreciated that both spools 18, 20 may be mounted on the respective spool support 14, 16 with a length of tape 19 wound thereon; i.e., the tape 19 may be partially transferred, for example it may be part-used. In this instance, neither spool 18, 20 is full and neither spool 18, 20 is empty.

A tag 50 may be associated with one of the spools 18, 20. The tag 50 may include data relating to the associated spool 18, 20, and the tape 19 stored thereon. The tag 50 may be an RF transmitter. The tag 50 may be an RF receiver. The tag 50 may be an RFID tag. The tag 50 may include read-only memory and/or read/write memory. The tag 50 may be mounted on the core 15, 17 of the spool 18, 20. The tag 50 may be mounted on an outer surface of the core 15, 17. Positioning the tag 50 on the outer surface of the core 15, 17 means that the tag 50 may be protected by tape 19 wound on the core, and is less likely to be damaged during installation, use and/or maintenance. However, it will be appreciated that the tag 50 may be positioned in an alternative location, for example the tag 50 may be embedded in the core 15, 17 or positioned on an inner surface of the core 15, 17. Both spools 18, 20 may have an associated tag 50.

The tape transfer apparatus 10 includes a reader 40. The reader 40 may be configured to receive signals from the tag 50 associated with one of the spools 18, 20. The reader 40 may be configured to transmit signals to the tag 50. The reader 40 may be configured to provide power to the tag 50. The reader 40 may be configured to transmit and/or receive radio frequency signals. The reader 40 may be an RFID reader. The reader may include a first part and a second part. The reader 40 may include an antenna 42. The antenna 42 may be operable to transmit and receive signals to and from the tag 50. The antenna 42 may be associated with one of the spool supports 14, 16. The antenna 42 may be positioned on one of the spool supports 14, 16. The antenna 42 may be positioned inside one of the spool supports 14, 16, for example inside the opening or hollow part of the spool support 14, 16 where such an opening or hollow part is provided. The antenna 42 or part of the antenna 42 may rotate about the axis 14a, 16a of the spool support 14, 16 with which it is associated. The antenna 42 may be positioned such that the antenna 42 is operable to transmit and/or receive signals to/from the tag 50 when the spool 18, 20 with which the tag 50 is associated is mounted on the spool support 14, 16 carrying the antenna 42. It will be understood that the materials from which the core 15, 17 with which the tag 50 is associated and the spool support 14, 16 with which the antenna 42 is associated are manufactured should be selected such that any distortion, interruption or blocking of signals between the tag 50 and the antenna 42 is minimised or avoided.

Positioning the antenna 42 on or in the spool support 14, 16 and the tag 50 on the core 15, 17 of the spool 18, 20 to be mounted on the spool support 14, 16 means that the antenna 42 is close to the tag 50 when the core 15, 17 is mounted on the spool support 14, 16. The distance between the tag 50 and the antenna 42 in use (i.e., when the spool 18, 20 with which the tag 50 is associated is mounted on its corresponding spool support 14, 16), may be approximately 2 mm to 20 mm. The distance between the tag 50 and the antenna 42 in use (i.e., when the spool 18, 20 with which the tag 50 is associated is mounted on its corresponding spool support 14, 16), may be substantially constant. The orientation of the antenna 42 relative to the tag 50 may be substantially fixed, for example by virtue of the engagement formation 151, 171 of the core 15, 17 with the corresponding engagement formation 141, 161 of the corresponding spool support 14, 16. The orientation of the antenna 42 relative to the tag 50 associated with the spool 18, 20 may be optimised, for example dependent on the field of transmission of the antenna.

The apparatus 10 may include a connection arrangement associated with the or each antenna 42. The connection arrangement may be operable to provide electrical energy and/or enable transfer of data between the associated antenna 42 and one or more other components of the apparatus 10. The connection arrangement 44 may be a wireless connection arrangement. For example, the connection arrangement 44 may be operable to supply electrical energy from a power source. The power source may be positioned on or in the body 11 of the apparatus 10, or even remotely from the apparatus 10. The connection arrangement may be operable to enable communication from/to the antenna 42, for example to enable the transfer signals and/or data to and/or from the antenna 42 from and/or to other components of the apparatus 10, for example a controller of the apparatus 10. The or each component which the antenna 42 may be communicable may be positioned on a part of the apparatus 10 to which the spool support 14, 16 with which the antenna 42 is associated is relatively moveable, for example the body 11 of the apparatus 10. The or each component or a subset of components with which the antenna 42 is communicable with may be remote from the apparatus 10.

The connection arrangement may include a transformer 44. The connection arrangement may include a rotary transformer. The transformer 44 may be an RF transformer 44. The connection arrangement 44 may include a first part 44a and a second part 44b. The first part 44a and the second part 44b may be moveable relative to one another. The second part 44b may be rotatable relative to the first part 44a, for example substantially about the axis 14a, 16a of the associated spool support 14, 16. The first part 44a may be mounted on a part of the apparatus 10 which remains substantially stationary in use. The first part 44a may be mounted on the body 11 of the apparatus 10.

The second part 44b of the transformer 44 may be mounted on a moveable part of the apparatus 10. The second part 44b of the transformer 44 may be positioned on a spool support 14, 16, i.e. the spool support 14, 16 upon which the spool 18, 20 associated with the tag 50 is mountable.

The first part 44a may include a first winding or coil 45. The first winding or coil 45 may include a connection 47 to connect the first coil 45 to one or more components of the apparatus 10, for example a power supply and/or a controller and/or RFID electronics. The first coil 45 may be physically connected to the components of the apparatus, for example the connection 47 may include one or more wires. The first coil 45 may be positioned on the body 11, for example on the base part 12. The first coil 45 may be positioned near to the motor 24, 26 associated with the relevant spool support 14, 16.

The second part 44b may include a second winding or coil 46. The second part 44b may include a connection 48 to connect the second coil 46 to the antenna 42. The connection 48 may be a physical connection and may include one or more wires.

Each winding or coil 45, 46 may be in the form of a closed loop. Each winding or coil 45, 46 may be substantially circular, elliptical or other appropriate shape. Each winding or coil 45, 46 may be formed from a conductor, e.g. copper or aluminium. Each winding or coil 45, 46 may be printed on a circuit board.

The first and second coils 45, 46 may be operable to transfer power and/or data between the first part 44a and the second part 44b of the connection arrangement. The first and second coils 45, 46 may be closely coupled. The first and second coils 45, 46 may be separated by an air gap. The connection may not require a ferromagnetic core.

The antenna 42 and the RF transformer 44 may be tuned and/or matched. The antenna 42 and the RF transformer 44 may be tuned using a known or standard impedance matching technique. The antenna 42 and transformer 44 may be tuned in real-time, for example using a known algorithm. Such tuning ensures that a connection between the antenna 42 and the RF transformer 44 is possible and efficient. An advantage of tuning the antenna-transformer is that maximum efficiency can be achieved with minimum power transmitted.

Controlling, for example fixing, the orientation of the antenna 42 relative to the tag 50 may be advantageous. The engagement formations 151, 171 of the core 15, 17 with which the tag 50 is associated and the engagement formations 141, 161 of the spool support 14, 16 with which the antenna 42 is associated may enable control of the orientation of the tag 50 relative to the antenna 42. It may be advantageous for the tag 50 to be substantially aligned with the antenna 42. The relative positions and/or orientations of the tag 50 and the antenna 42 may depend upon the design and/or characteristics of the tag 50 and/or the antenna 42, and may be selected and controlled as appropriate. The antenna 42 or a part of the antenna 42 may be rotatable about the axis 14a, 16a of the spool support 14, 16 upon which the spool 18, 20 associated with the tag is mountable. The antenna 42 or a part of the antenna may be rotatable relative to the body 11 of the apparatus 10.

RF shielding 60 may be provided to reduce or eliminate eddy currents, for example. Eddy currents may interfere with signals from the tag 50, for example. The RF shielding 60 may include a first part 60a and a second part 60b. The first part 60a of the RF shielding may be associated with the first part 44a of the transformer 44. The second part 60b of the RF shielding 60 may be associated with the second part 44b of the transformer 44. Providing RF shielding 60 may also reduce radiated RF power outside the transformer 44 and the apparatus 10. RF shielding 60 may enable the apparatus to comply with EMC and other regulations. The RF shielding 60 may include one or more plates or casings.

A kit may include a tape transfer apparatus 10 and at least one spool 18, 20. The at least one spool 18, 20 may be a consumable. The at least one spool 18, 20 may be replaceable. The at least one spool 18, 20 may be mountable on the respective spool support 14, 16 directly or indirectly, for example by means of a cassette.

Where a cassette is provided, each spool 18, 20 is mounted on the cassette and the cassette is engaged with the base 12 of the apparatus 10. Where a cassette is provided, the first part 44a of the transformer 44 may be provided on the cassette. An additional physical electrical/electronic connection may be required where the first part 44a of the transformer 44 is provided on the cassette.

In use, each spool 18, 20 is mounted on a corresponding one of the spool supports 14, 16. The tag 50 is provided on one of the spool cores 15, 17, and may include data, for example characteristics, parameters and/or identification data relating to the spool 18, 20 and/or the tape 19 wound thereon. Once the spool 18, 20 carrying the tag 50 is mounted on its corresponding spool support 14, 16, the antenna 42 in or on the spool support 14, 16 and the tag 50 are in communication range of one another. Information may be updated on the tag during use of the tape, for example to update an amount of tape remaining on the spool 18, 20.

The antenna 42 may be powered by a power supply on the base 12, or another stationary part of the apparatus 10. The antenna 42 rotates as the spool support 14, 16 is rotated by the motor 24, 26, to transfer tape from one of the spools 18, 20 to the other. The antenna 42 may be in a fixed orientation relative to the tag 50 to enable substantially continuous communication between the tag and the antenna 42 even during rotation of the spool 18, 20, and the associated tag 50. The antenna 42 rotates with the tag 50 by virtue of the engagement formations 141, 151, 161, 171. Alternatively, the antenna 42 may be configured such that its transmission field is substantially 360°, or at least configured such that the tag 50 and the antenna 42 are able to communicate substantially continuously, even during rotation of the spool 18, 20 and the associated tag 50.

The transformer 44 is provided to transfer power and or data to and/or from the rotating tag 50 (and antenna 42) to substantially stationary components of the apparatus 10, for example wireless transmission of the data read from the tag 50 by the reader 40 to a controller which is positioned on a stationary part of the apparatus 10 may be necessary, for example to ascertain that the spool 18, 20 is an appropriate spool to be used in the apparatus 10. Characteristics of the tape 19 may be updated on the tag 50, for example the amount of tape used and/or remaining on the spool 18, 20.

The configuration of the reader 40 and the connection is advantageous as it enables the antenna 42 to be located a short and substantially constant distance from the tag 50 when the spool 18, 20 with which the tag 50 is associated is mounted on the spool support 14, 16 associated with the antenna 42. The configuration of the reader 40 enables at least a part of the reader 40 (i.e. the antenna 42) to be positioned on a moving part of the tape transfer apparatus 10, for example on a rotating part of the tape transfer apparatus 10. The distance between the tag 50 and the reader 40 may be substantially constant. The distance between the tag 50 and at least a part of the reader 40 may be smaller than in known tape transfer apparatus where the reader is mounted on a stationary part of the apparatus, and positioned so as not to interfere with the tape, and to enable accommodation of a full spool.

A relatively short and substantially constant distance between the tag 50 and the reader 40 is advantageous since a lower power RF signal may be used compared with known arrangements where the distance between the tag and the antenna must be large enough to accommodate a full spool. This reduces the radiated RF power outside the apparatus 10, which in turn, this reduces compliance issues for the apparatus 10 in numerous countries around the world.

The antenna 42 may be configured to enable improved transmission, compared with a standard RFID antenna. The shape and/or configuration of the antenna 42 may be selected such that the tag 50 is permanently situated in the field of the antenna 42, when the spool 18, 20 with which the tag is associated is mounted on its spool support. The shape and/or configuration of the antenna 42 such that the tag 50 is always positioned in the field of the antenna means that it is not necessary to control or fix the position of the tag 50 (and hence the associated spool 18, 20) relative to the antenna 42 (and hence the spool support 14, 16), since reliable communication is ensured between the tag 50 and the antenna 42 by the shape and/or configuration of the antenna 42.

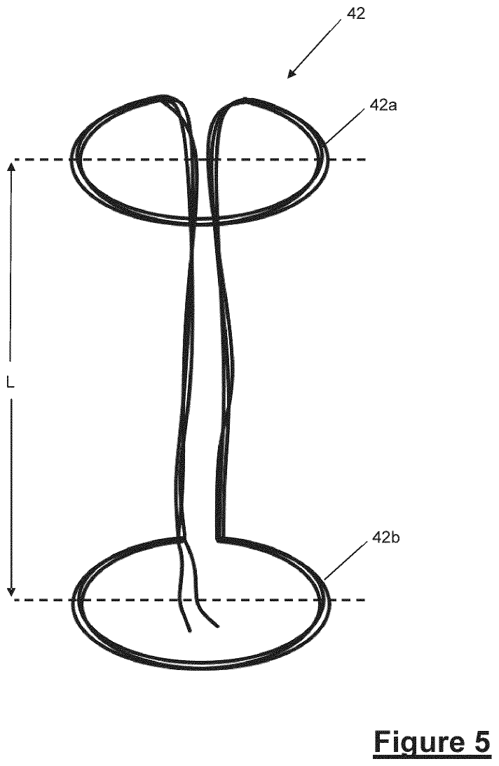

In an example, as shown in FIG. 5, for example, the antenna 42 may have a first antenna coil 42a, and a second antenna coil 42b. Each of the first and second antenna coils 42a, 42b may be substantially circular. The first and second antenna coils 42a, 42b may be substantially parallel with one another. The first and second antenna coils 42a, 42b may be spaced apart by an antenna length L. The first and second antenna coils 42a, 42b may be connected to one another. The antenna 42 may be configured by bending or twisting one or more cables, or a flexible printed circuit board into the desired antenna shape.

An advantage of an antenna configured in a manner such as that shown in FIG. 5 is that it is able to transmit through approximately 360°. The field of transmission may be substantially toroidal. The field of transmission may be substantially cylindrical.

Where the antenna 42 is configured to encompass the position of the tag 50 substantially constantly, for example by being configured to have a substantially 360° field of transmission, it may not be necessary to fix the orientation of the antenna 42 relative to the tag 50, and the engagement formations 141, 161 of the spool supports 14, 16 and the engagement formations 151, 171 of the cores 15, 17 may not be required.

Thus it will be appreciated that an improved configuration of an RFID tag antenna and connection arrangement is provided.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A tape transfer apparatus including a base part and at least one spool support for receiving a spool of tape, the spool support being configured to rotate about a first axis of rotation relative to the base part, the tape transfer apparatus also including an RFID reader configured to read data from an RFID tag included with a spool of tape, when the spool of tape including the RFID tag is mounted on the spool support, wherein at least a part of the RFID reader is positioned on or in a part of the spool support.

2. A tape transfer apparatus according to claim 1 wherein an antenna of the RFID reader is positioned on or in a part of the spool support.

3. A tape transfer apparatus according to claim 1 including a wireless connection arrangement to transfer at least one of electrical energy, data and/or signals between a moving part of the tape transfer apparatus and a stationary part of the tape transfer apparatus.

4. A tape transfer apparatus according to claim 3 wherein the wireless connection arrangement is configured to transfer at least one of electrical energy, data and/or signals between the antenna of the RFID reader and a component positioned on the base part.

5. A tape transfer apparatus according to claim 3 wherein the wireless connection arrangement is configured to transfer at least one of electrical energy, data and/or signals between the antenna of the RFID reader and a component positioned remotely from the base.

6. A tape transfer apparatus according to claim 3 wherein a first part of the connection arrangement is positioned on the base part and a second part of the connection arrangement is positioned on or in a part of the spool support, the second part of the connection arrangement being moveable relative to the first part of the connection arrangement.

7. A tape transfer apparatus according to claim 6 wherein the first part of the connection arrangement includes a first coil and the second part of the connection arrangement includes a second coil.

8. A tape transfer apparatus according to claim 3 wherein the connection arrangement is an RF transformer.

9. A tape transfer apparatus according to claim 7 wherein at least one of the first or the second coil is a wound conductive material or a winding on a flexible circuit board.

10. A tape transfer apparatus according to claim 7 wherein the first coil and the second coil are separated from each other by an air gap without a ferromagnetic core.

11. A tape transfer apparatus according to claim 1 wherein the tape transfer apparatus is a thermal transfer printing apparatus.

12. A kit including:
a tape transfer apparatus including a base part and at least one spool support for receiving a spool of tape, the spool support being configured to rotate about a first axis of rotation relative to the base part, the tape transfer apparatus also including an RFID reader, wherein at least a part of the RFID reader is positioned on or in a part of the spool support; and
a spool of tape including an RFID tag;
wherein the RFID reader is configured to read data from the RFID tag included with the spool of tape, when the spool of tape including the RFID tag is mounted on the spool support.

13. A kit according to claim 12 wherein the spool of tape is a consumable which is replaceable in the tape transfer apparatus.

14. A kit according to claim 12 wherein the spool of tape includes a core configured to receive a length of tape wound around it, the core being directly mountable on the spool support of the tape transfer apparatus.

15. A kit according to claim 14 wherein the RFID tag is mounted on an outer surface of the core of the spool of tape.

16. A kit according to claim 12 wherein the tape transfer apparatus is a thermal transfer printing apparatus.
